(19) United States
(12) Patent Application Publication
(10) Pub. No.: US 2007/0100886 A1
(43) Pub. Date: May 3, 2007

(54) API and schemas for dedicated customer service representative interface

(75) Inventors: Curt A. Steeb, Redmond, WA (US); Gokul P. Thirumalai, Bellevue, WA (US); Jeffrey Alan Herold, Bellevue, WA (US); Zeyong Xu, Issaquah, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 11/367,258

(22) Filed: Mar. 3, 2006

Related U.S. Application Data
(60) Provisional application No. 60/732,967, filed on Nov. 3, 2005.

(51) Int. Cl. G06F 7/00

(52) U.S. Cl. 707/104.1

(57) ABSTRACT

A pay-per-use or subscription computer may require customer assistance for both technical and business purposes. A customer service interface available via a web service may be used to provide customer service offered by a provider at a different level of the distribution chain. The web service may be focused in three areas, each exposing various methods. The three areas may include customer/computer data, distribution/sales data, and business or service level adjustments.

### BACKGROUND

The pay-as-you-go or subscription model for making computers available to low-income or otherwise disadvantaged users promises to expand the marketplace for computers well beyond the current horizon. As with cellular telephones, the ability to have a computer without significant up-front costs in exchange for regular payments will greatly increase the availability of computers to a wide potential audience.

However, unlike cellular telephones, where the network provider is also the service provider, managing computers through a hierarchy of tiers of distribution and service providers while maintaining security, personal privacy, and data integrity offers a significant challenge.

### SUMMARY

A customer may enter into a business relationship with a provider to get the use of a computer, a related service, or both, on a metered basis. The metering may be based on a subscription where a fee is paid on a routine basis, such as month. Alternately, the metering may be based on a pay-per-use model where money or points are used in exchange for measured use by time, CPU cycles, bytes of data processed, or another metric. More than one relationship may exist, for example, the computer, a game or software package, and a peripheral may be sourced from separate distributors with separate agreements for each. An overall scheme owner, or a customer service provider, may need access to information about not only the customer and product(s) supported, but also about each distribution channel in order to support the customer base.

A customer service representative (CSR) web tool offers a variety of user support mechanisms for use by partners at one or more levels of the distribution and support chain. Three web services make up the core of the CSR web tool: a core data reader (CDR), a Distribution Data Reader (DDR), and a Resolutions service. The core data reader may provide information about the customer or related equipment, the distribution data reader may provide information about the distribution chain, and the resolutions service may allow corrective actions to be taken to resolve issues due to errors or for customer satisfaction. The Resolutions service may also allow distribution channel features, for example, Point-of-Sale (POS) registration for new customers.

### BRIEF DESCRIPTION OF THE DRAWINGS

FIG. 1 is a simplified and representative block diagram of a computer suitable for use in a pay-per-use or subscription business model;

FIG. 2 is a simplified and representative block diagram of a computer network supporting the computer of FIG. 1;

FIG. 3 is a block diagram illustrating the relationships between function elements of a customer service support environment; and

FIG. 4 is a method of processing a request related to supporting the pay-per-user or subscription business model.

### DETAILED DESCRIPTION OF VARIOUS EMBODIMENTS

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

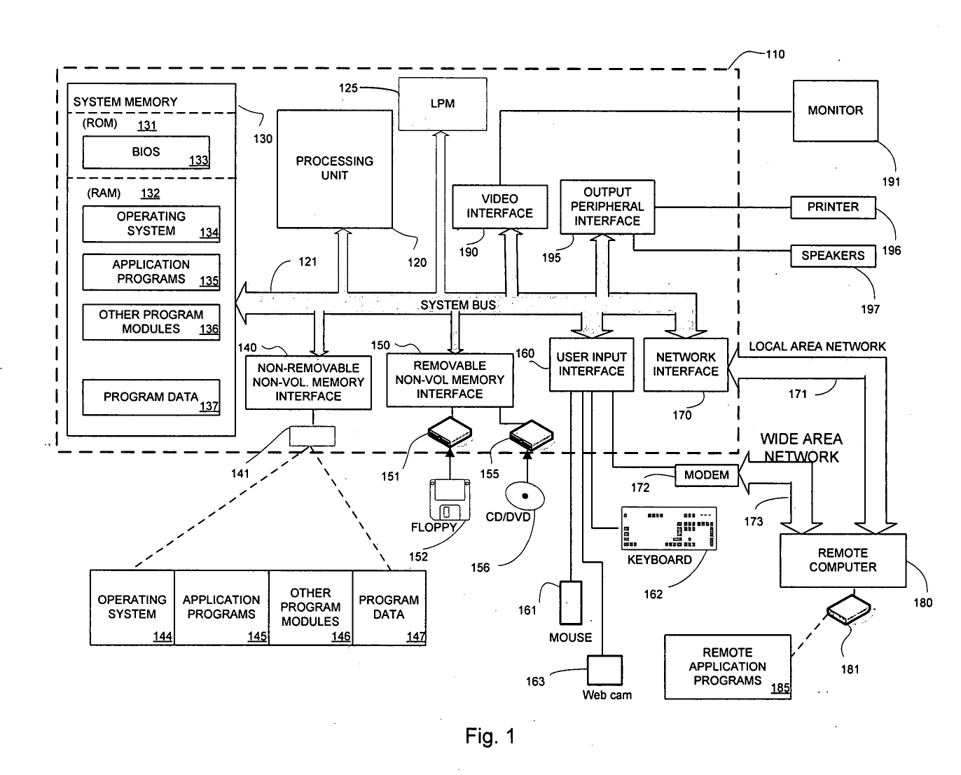

FIG. 1 illustrates a computing device in the form of a computer 110 that may be connected to the network 10 and used to implement one or more components of the dynamic software provisioning system. Components of the computer 110 may include, but are not limited to a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 110 may also include a lower provisioning module (LPM) 125. The lower provisioning module 125 is a hardware component of a license provisioning service and has a corresponding software component, an upper provisioning module (not depicted). Briefly, the LPM 125 facilitates pay-as-you-go or pay-per-use operation of the computer 110. The LPM 125 manages metering usage, imposing sanctions when metered use is expired, and manages the request, receipt, and processing of data for replenishing the computer 110 for additional metered use. The lower provisioning module 125 may be implemented in hardware as depicted, but may be instantiated in software given an appropriate execution environment in consideration of expected security risks.

The computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Combinations of the any of the above should also be included within the scope of computer readable media.

The system memory 130 includes computer storage media in the form of volatile memory, nonvolatile memory, or both, such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data, program modules, or both, that are immediately accessible to or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Another input device may be a camera for sending images over the Internet, known as a web cam 163. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

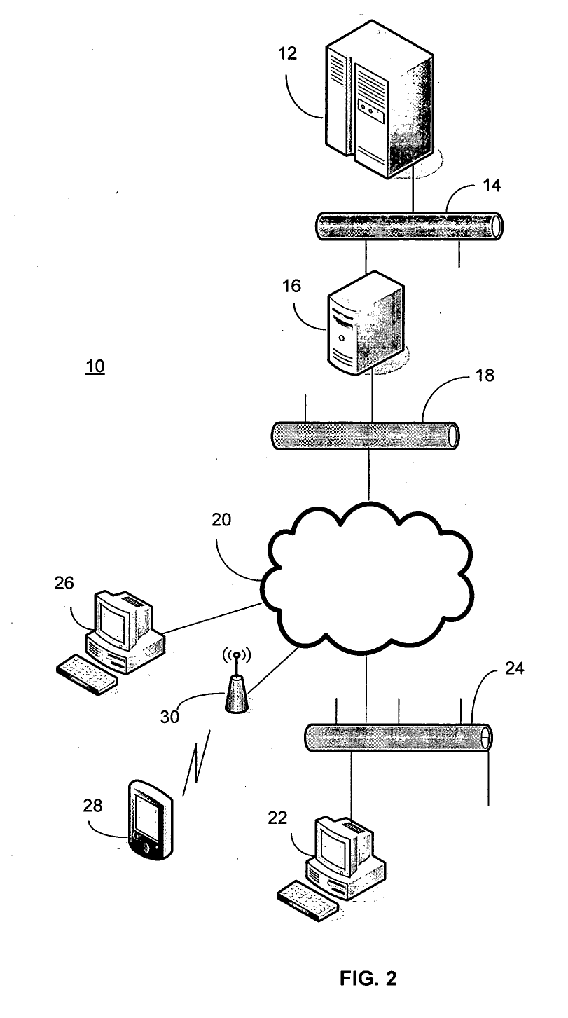

FIG. 2 is a simplified and representative block diagram of one embodiment of a network hierarchy supporting the web-service based customer service offering. The network hierarchy may be similar to other known three-tier networks. A data center backend server 12, may be coupled to a internal, or private backend network 14. A data center front-end server 16 may be coupled via a private front-end network 18 to a wide-area network 20, such as the Internet. A customer-service computer 22 may be coupled to a partner front-end network 24 and then to the wide-area network 20. In another embodiment, the customer-service computer 22 may be connected directly to the private network 18 via a dedicated connection or virtual private network (not depicted). A pay-per-use or subscription computer 26 may be coupled to the wide-area network 20 directly or via an intermediate network (not depicted). Another pay-per-use or subscription device 28, such as a personal digital assistant (PDA) may be coupled to the wide-area network 20 via a wireless network 28. While this may be a fairly typical network topology, other topologies are common and are equally applicable. For example, the front-end network 18 and backend network 14 may be common, or in another embodiment may be further separated by other intermediate networks.

In operation, the pay-per-use or subscription computer 26 may be provided at a subsidized rate by a partner, such as an Internet service provider, while management of the pay-per-use or subscription provisioning may be provided by a scheme operator. The scheme operator may be associated with the data center front-end and backend computers 12 16 described above. Requests from the user computer 26 to the data center front end 16 may include initial provisioning using an init key or routine re-provisioning, such as purchase of provisioning packets or pay-as-you-go operation. Further details regarding the operation of pay-per-use or subscription computer 26 and other participant entities may be found in co-pending U.S. patent applications Ser. No. 10/989122, filed Nov. 15, 2004, and Ser. No. 11/006837, filed Dec. 8, 2004.

In some business scenarios, the end-user support role may be taken by the partner, represented in FIG. 2 by the customer service computer 22. As the end user transactions may have occurred directly with the scheme operator, access to transaction and other customer service information may need to be provided to the partner, particularly the representative customer service computer 22.

To that end, an application programming interface and associated data schemas may be provided for both accessing and updating scheme operator data and information. Offered as a web-based tool, access may be provided using three or more functions, in one embodiment, offered as three separate web services. In an exemplary embodiment, the three web services are a core data reader class, a distribution data reader class, and a Resolutions class. Briefly, methods associated with the core data reader provide access to configuration information about computers or other devices known in the pay-per-use or subscription scheme and allows them to be found or organized by a variety of queries and filters. The distribution data reader class exposes methods providing information on pending transactions including specific information about individual provisioning packets. The resolutions class supports methods allowing the customer service representative to update or changed data corresponding to a pay-per-use or subscription computer or device, such as computer 26 and device 28. Illustrative methods include adding prepaid time canceling or creating subscriptions and steps to release a device from a sanctioned mode of operation, after suspected fraud may have been detected.

A specific embodiment of each of the classes and their related methods are discussed in detail below, although it should not be construed as limiting the function or purpose to the specific classes and methods.

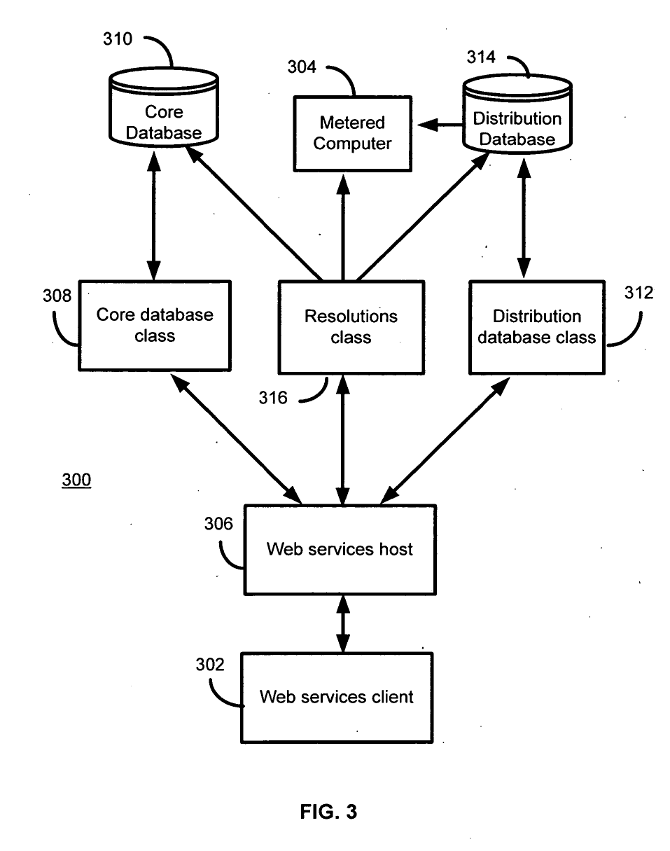

As shown in FIG. 3, three classes may be used to expose methods of retrieving data and resolving issues related to customer service or data maintenance. A system 300 for delivering and supporting metered computers may include a web services client 302, and at least one metered computer 304. The web services client 302 may communicate with one or more web services hosts, represented by web services host 306. The web service host 306 may process requests and direct data, as appropriate, to a core database class 308, which in turn may be in communication with a core database 310. similarly, the web services host 306 may be in communication with a distribution database class 312, that in turn may be in communication with distribution database 314. The web services host 306 may also be in communication with a resolutions class 316 that may have the ability to alter data in either the core database 310 or the distribution database 314. The resolutions class 316 may also be able to directly interact with the metered computer 304 or may be able to initiate activity affecting the metered computer 304, for example, by sending a message to the distribution database 314 to reissue a provisioning packet to the metered computer 304 for the purpose of adding usage time or altering a configuration of the metered computer 304.

Each of the classes exposes a representative set of methods as discussed in greater detail below. However, the method shown are representative of typical functions required to support a metered use computer, whether the particular scheme is pay-per-use, subscription, or another business model. The representative classes and methods below provide a generic support environment suitable for supporting any of the metered use business models.

CoreDataReader Class

The CoreDataReader class contains an instantiation constructor and methods to query data in the Core Database, corresponding to customers and their associated computer device or devices.

CoreDataReader Constructor
Constructor to instantiate the class.
public CoreDataReader( );

CoreDataReader Methods—The methods of the CoreDataReader are listed below in Table 1. Each method is discussed in more detail below.

TABLE 1
CoreDateReader Methods

| | |
|---|---|
| GetConfiguration | Returns all PowerLine Server Configuration |
| | values in the server database. |
| GetDeviceByAccount | Returns device for which time was bought |
| | using a specific account. |
| GetDeviceByHard- | Returns devices matching the hardware ID |
| wareID | provided. |
| GetDeviceById | Returns device corresponding to the ID |
| | provided. |
| GetDeviceByInitKey | Returns all devices matching the initKey |
| | provided. |
| GetDeviceByName | Returns device matching the deviceName |
| | provided. |
| GetEmptyPacket | This webservice method is not meant to be |
| | called. This is here to ensure WSDL |
| | generation of this class |
| GetEmptyPrepaid- | This webservice method is not meant to be |
| Device | called. This is here to ensure WSDL |
| | generation of this class |
| GetEmptySub- | This webservice method is not ment to be |
| scriptionDevice | called. This is here to ensure WSDL |
| | generation of this class |
| GetJobByDeviceId | Returns all job related information that |
| | matches the specific deviceId. Several filters |
| | can be applied to this query- including date |
| | filters, number of records and heirarchical |
| | option. |
| GetJobByDeviceName | Returns all job related information for devices |
| | that match the specific deviceName. Several |
| | filters can be applied to this query- including |
| | date filters, number of records and |
| | heirarchical option. |
| GetJobByHardwareId | Returns all job related information for devices |
| | that match the specific hardwareId. Several |
| | filters can be applied to this query- including |
| | date filters, number of records and |
| | heirarchical option. |
| GetJobByRequester | Returns all job related information that |
| | matches the specific requester. Several filters |
| | can be applied to this query- including date |
| | filters, number of records and heirarchical |
| | option. |
| GetJobChildrenBy- | Returns all child jobs for the given parent job. |
| ParentJobId | |
| GetPrepaidPurchase- | Returns all prepaid purchases made using a |
| ByAccount | specific account. |
| GetPrepaidPurchase- | Returns prepaid purchase that matches the |
| ByTrackingId | given Tracking ID. |

Details of each CoreDataReader method follow:

CoreDataReader.GetConfiguration Method

Returns all PowerLine Server Configuration values in the server database. public ServerConfiguration[ ] GetConfiguration( ); Return Value Array of configuration values.

CoreDataReader.GetDeviceByAccount Method

Returns device for which time was bought using a specific account.
public Device[ ] GetDeviceByAccount(

string account

);
Parameters
account

Account (PUID) which to search for. This parameter cannot be
null or empty-string, or longer than 17 characters.

Return Value
Devices that for which time was bought using the specified account. If no
devices are found, this method returns null.

CoreDataReader.GetDeviceByHardwareId Method

Returns devices matching the hardware ID provided.
public Device[ ] GetDeviceByHardwareId(

string hardwareId

);
Parameters
hardwareId

HardwareId of the device to search for. This parameter cannot be
null or empty-string, and cannot be longer than 50 characters.

Return Value
Devices that match the hardwareId provided. If no devices are found,
this method returns null.

CoreDataReader.GetDeviceById Method

Returns device corresponding to the ID provided.
public Device GetDeviceById(

int id

);
Parameters
id

Id of the Device that should be returned. This parameter must
be non-negative.

Return Value
Device corresponding to the ID provided. If no devices found, this method
returns null.

CoreDataReader.GetDeviceByInitKey Method

Returns all devices matching the initKey provided.
public Device[ ] GetDeviceByInitKey(

string initKey

);
Parameters
initKey

InitKey of the device to search for. This parameter cannot be
null or empty-string, and cannot be longer than 25 characters.

Return Value
Devices that match the initKey provided. If no devices are found,
this method returns null.

CoreDataReader.GetDeviceByName Method

Returns device matching the deviceName provided.
public Device GetDeviceByName(

string deviceName

);
Parameters
deviceName

deviceName of the device to search for. This parameter cannot
be null or empty-string, and cannot be longer than 50 characters.

Return Value
Devices that match the deviceName provided. If no devices are found, this
method returns null.

All the GetDeviceBy . . . methods (GetDeviceByAccount, GetDeviceByHardwareId, GetDeviceById, GetDeviceByInitKey, GetDeviceByName) may return information that is based on the schema of table 1, following:

TABLE 1
The namespace ‘s’ refers to the standard:

xmlns:s=“http://www.w3.org/2001/XMLSchema”

<s:complexType name=“Device”>

<s:sequence>

<s:element minOccurs=“0” maxOccurs=“1” name=“ActivationDate”

type=“s:string”/>

<s:element minOccurs=“0” maxOccurs=“1” name=“AutoDiagnostics”

type=“tns:ArrayOfAutoDiagnostic”/>

<s:element minOccurs=“0” maxOccurs=“1” name=“Configuration”

type=“tns:DeviceConfiguration”/>

<s:element minOccurs=“0” maxOccurs=“1” name=“HardwareId” type=“s:string”

/>

<s:element minOccurs=“1” maxOccurs=“1” name=“Id” type=“s:int”/>
<s:element minOccurs=“0” maxOccurs=“1” name=“LastActivityDate”

type=“s:string”/>

<s:element minOccurs=“1” maxOccurs=“1” name=“LastSequenceNumber”

type=“s:int”/>

<s:element minOccurs=“0” maxOccurs=“1” name=“Market” type=“s:string”/>
<s:element minOccurs=“0” maxOccurs=“1” name=“Name” type=“s:string”/>
<s:element minOccurs=“0” maxOccurs=“1” name=“Status” type=“s:string”/>
<s:element minOccurs=“0” maxOccurs=“1” name=“Type” type=“s:string”/>
<s:element minOccurs=“0” maxOccurs=“1” name=“UnderwriterProgramId”

type=“s:string”/>

</s:sequence>

</s:complexType>

The data elements Id and LastSequenceNumber are mandatory, while the others are optional. The Id may be an indentifier associated with the activation account, as opposed to the HardwareID, which is associated with the particular computer. ActivationDate may be the date the computer was first provisioned and added to the underwriter or support service system. AutoDiagnostics may refer to the version of diagnostics available at a computer with a given HardwareId. LastActivityDate may refer to the last date/time a user added value to the computer or the last signal, such as a heartbeat, received from the computer at the provisioning system. LastSequenceNumber may be the last sequence number associated with a transaction, such as generation of a provisioning packet for additional minutes of use. Market may refer to the market where the device is sold. Name may be a unique identifier used to identify the device. Status may refer to the status of the device, such as activated or deactivated. Type may refer to the type of device, such as Prepaid or Subscription. UnderwriterProgramId may be a system unique identifier that is a combination of the HardwareID and another number assigned by an underwriter to a particular offer package. For example, one underwriter offer package may be for a computer and operating system and another underwriter offer package may be for a office software suite and a printer. The combination of HardwareID and offer package number creates a unique identifier by underwriter,by computer, by feature.

CoreDataReader.GetEmptyPacket Method
This webservice method is not meant to be called. This is here to ensure WSDL generation of this class
public Packet GetEmptyPacket( );
Return Value
Null

CoreDataReader.GetEmptyPrepaidDevice Method

This webservice method is not meant to be called. This is here to ensure WSDL generation of this class public PrepaidDevice GetEmptyPrepaidDevice( ); Return Value Null

CoreDataReader.GetEmptySubscriptionDevice Method
This webservice method is not meant to be called. This is here to ensure WSDL generation of this class
public SubscriptionDevice GetEmptySubscriptionDevice( );
Return Value
Null

CoreDataReader.GetJobByDeviceId Method

Returns all job related information that matches the specific deviceId.
Several filters can be applied to this query- including date filters,
number of records and heirarchical option.
public Job[ ] GetJobByDeviceId(

int deviceId,
string startDate,
string endDate,
int lastN,
string type,
bool hierarchical

);
Parameters
deviceId

ID of the device to be used in the job search query. This
parameter must be non-negative.

startDate

Start date filter for the job search. If this parameter is null or
empty-string, no start date filter is applied.

endDate

End date filter for the job search. If this parameter is null or
empty-string, no end date filter is applied.

lastN

Number of most recent records to return. This parameter must be
non-negative. If this parameter is zero, this filter is ignored.

type

Type of job to search for. Inputting NULL or empty-string for
this parameter returns jobs of all types. Refer to Job.Type for
more information on this parameter.

hierarchical

Determines whether the job array returned has hierarchical or
flat structure. ‘true’ indiciates hierarchical and returns child jobs
as children in the datastructure. ‘false’ indicates a flat structure
and the child jobs of the given job are set to null.

Return Value
(Filtered) Jobs created for the device that match the given device ID.

CoreDataReader.GetJobByDeviceName Method

Returns all job related information for devices that match the specific
deviceName. Several filters can be applied to this query- including date
filters, number of records and heirarchical option.
public Job[ ] GetJobByDeviceName(

string deviceName,
string startDate,
string endDate,
int lastN,
string type,
bool hierarchical

);
Parameters
deviceName

Device name to find information for. This parameter cannot be
null or empty-string, and cannot be longer than 50 characters.

startDate

Start date filter for the job search. If this parameter is null or
empty-string, no start date filter is applied.

endDate

End date filter for the job search. If this parameter is null or
empty-string, no end date filter is applied.

lastN

Number of most recent records to return. This parameter must be
non-negative. If this parameter is zero, this filter is ignored.

type

Type of job to search for. Inputting NULL or empty-string
for this parameter returns jobs of all types. Refer to Job.Type for
more information on this parameter.

hierarchical

Determines whether the job array returned has hierarchical or
flat structure. ‘true’ indiciates hierarchical and returns child jobs
as children in the datastructure. ‘false’ indicates a flat structure
and the child jobs of the given job are set to null.

Return Value
(Filtered) Jobs created for the device that match the given deviceName.

CoreDataReader.GetJobByHardwareId Method

Returns all job related information for devices that match the specific
hardwareId. Several filters can be applied to this query- including date
filters, number of records and heirarchical option.
public Job[ ] GetJobByHardwareId(

string hardwareId,
string startDate,
string endDate,
int lastN,
string type,
bool hierarchical

);
Parameters
hardwareId

HardwareId of the device to find information for. This parameter
cannot be null or empty-string, and cannot be longer than
50 characters.

startDate

Start date filter for the job search. If this parameter is null or
empty-string, no start date filter is applied.

endDate

End date filter for the job search. If this parameter is null or
empty-string, no end date filter is applied.

lastN

Number of most recent records to return. This parameter must
be non-negative. If this parameter is zero, this filter is ignored.

type

Type of job to search for. Inputting NULL or empty-string for
this parameter returns jobs of all types. Refer to Job.Type for
more information on this parameter.

hierarchical

Determines whether the job array returned has hierarchical or
flat structure. ‘true’ indiciates hierarchical and returns child jobs
as children in the datastructure. ‘false’ indicates a flat structure
and the child jobs of the given job are set to null.

Return Value
(Filtered) Jobs created for the device that match the given hardware ID.

CoreDataReader.GetJobByRequester Method

Returns all job related information that matches the specific requester.
Several filters can be applied to this query- including date filters, number
of records and heirarchical option.
public Job[ ] GetJobByRequester(

string requester,
string startDate,
string endDate,
int lastN,
string type,
bool hierarchical

);
Parameters
requester

Requester name to be used in the job search query. This
parameter cannot be null or empty-string, and cannot be
greater than 46 characters (A prefix of “CSR:” is automatically
added to the requester name).

startDate

Start date filter for the job search. If this parameter is null or
empty-string, no start date filter is applied.

endDate

End date filter for the job search. If this parameter is null or
empty-string, no end date filter is applied.

lastN

Number of most recent records to return. This parameter must be
non-negative. If this parameter is zero, this filter is ignored.

type

Type of job to search for. Inputting NULL or empty-string for
this parameter returns jobs of all types. Refer to Job.Type for
more information on this parameter.

hierarchical

Determines whether the job array returned has hierarchical or
flat structure. ‘true’ indiciates hierarchical and returns child jobs
as children in the datastructure. ‘false’ indicates a flat structure
and the child jobs of the given job are set to null.

Return Value
(Filtered) Jobs created for the device that match the given requester.

CoreDataReader.GetJobChildrenByParentJobId Method

Returns all child jobs for the given parent job.
public Job[ ] GetJobChildrenByParentJobId(

long parentJobId,
bool hierarchical

);
Parameters
parentJobId

ID of the parent job to be used in the job search query. This
parameter must be non-negative.

hierarchical

Determines whether the job array returned has hierarchical
or flat structure. ‘true’ indiciates hierarchical- the returned jobs
are ordered hierarchically in the datastructure array. ‘false’
indicates a flat structure.

Return Value
All child jobs that match the given Parent Job ID.

All the GetJobBy . . . methods listed above (GetJobByDeviceId, GetJobByDeviceName, GetJobByHardwareId, GetJobByRequester) may return information that is based on the schema of Table 2, following:

The namespace ‘s’ refers to the standard:

xmlns:s=“http://www.w3.org/2001/XMLSchema”

<s:complexType name=“Job”>

<s:sequence>

<s:element minOccurs=“0” maxOccurs=“1” name =“Children” type=“tns:ArrayOfjob” />
<s:element minOccurs=“1” maxOccurs=“1” name=“DeviceId” type=“s:int” />
<s:element minOccurs=“1” maxOccurs=“1” name=“Id” type=“s:long” />
<s:element minOccurs=“0” maxOccurs=“1” name=“Log” type=“tns:ArrayOfLog” />
<s:element minOccurs=“1” maxOccurs=“1” name=“ParentId” type=“s:long” />
<s:element minOccurs=“0” maxOccurs=“1” name=“ParentType” type=“s:string” />
<s:element minOccurs=“0” maxOccurs=“1” name=“Requester” type=“s:string” />
<s:element minOccurs=“0” maxOccurs=“1” name=“Status” type=“s:string” />
<s:element minOccurs=“0” maxOccurs=“1” name=“Type” type=“s:string” />

</s:sequence>

</s:complexType>

The schema requires a DeviceID, an ID and a ParentID. Other return data elements are optional based on the data available and the particular method called. Children may refer to child elements in the parent-child relationship of the job hierarchy, such as a Packet job may be a child of Prepaid job. Log may refer to logs associated with the job, such as success or failure logs. ParentType may indicate the type of the parent job in a parent-child relationship of the job heirarchy. Requester may indicate the requester associated with the job, such as a CSR personnel's name. Status and Type are values that may indicate the current status and type of the job.

CoreDataReader.GetPrepaidPurchaseByAccount Method

Returns all prepaid purchases made using a specific account.
public PrepaidPurchase[ ] GetPrepaidPurchaseByAccount(

string account,
string startDate,
string endDate,
int lastN

);
Parameters
account

Passport User ID (PUID) used for the purchases

startDate

Start date filter for the job search. If this parameter is null or
empty-string, no start date filter is applied.

endDate

End date filter for the job search. If this parameter is null or
empty-string, no end date filter is applied.

lastN

Number of most recent records to return. This parameter must
be non-negative. If this parameter is zero, this filter is ignored.

Return Value
(Filtered) Prepaid purchases made using the specified account.

CoreDataReader.GetPrepaidPurchaseByTrackingId Method

Returns prepaid purchase that matches the given Tracking ID.
public PrepaidPurchase GetPrepaidPurchaseByTrackingId(

string trackingId

);
Parameters
trackingId

Tracking ID of the purchase to search for. This parameter cannot
be null or empty-string. This parameter must also adhere to a
standardized GUID format. Please refer to Guid Constructor-
(String) for the allowable formats for this string input.

Return Value
Prepaid purchase matching the given Tracking ID.

DistributionDataReader Class: Contains methods to query data in the Distribution Database. The Distribution Data Reader exposes methods for retrieving information from the distribution database, a database with information about provisioning packet transactions, past, current or pending.

System.Object

System.ComponentModel.MarshalByValueComponent
System.Web.Services.WebService
   public class DistributionDataReader: WebService Thread Safety: This type is safe for multithreaded operations. Remarks This web service queries on the DistributionDB. The methods exposed by the class execute as read-only queries. The DistributionDB only stores the latest cache information from the CoreDB. Because of this, the webservice can potentially connect to a live DistributionDB. Since connections to a live database can be expensive, and since logically the queries act on a different database, the security applied to this web service may differ from that of CoreDataReader.

DistributionDataReader Members

DistributionDataReader Constructor
Nothing to do in constructor.
public DistributionDataReader( );

DistributionDataReader Methods—The methods of the DistributionDataReader are listed below in Table 2. Each method is discussed in more detail below.

Public Instance Methods

TABLE 2
DistributionDataReader Methods

| | |
|---|---|
| GetBootstrapByHardwareId | Returns all bootstrap packets waiting for |
| | download by the device with the specific |
| | hardwareId. |
| GetBootstrapByInitKey | Returns all bootstrap entries in the database |
| | for a specific initkey. |
| GetPacketByHardwareId | Returns all packets waiting for download by |
| | the device with the specific hardwareId. |
| GetPacketById | Returns packet corresponding to a specific |
| | Packet ID. |
| GetRequestLogByHard- | Returns all Request Logs in the database |
| wareId | for a specific hardwareId, filtered by start |
| | and end dates. |

DistributionDataReader Methods

DistributionDataReader.GetBootstrapByHardwareId Method

Returns all bootstrap packets waiting for download by the device
with the specific hardwareId.
public DistributionBootstrap[ ] GetBootstrapByHardwareId(

string hardwareId

);
Parameters
hardwareId

Hardware ID of the device to search bootstrap packets for. This
parameter cannot be null. There is a limit of 50 characters for
the length of the hardwareId.

Return Value
DistributionBootstrap array containing packets in the distribution
database waiting for download by given Hardware ID. If no
packets are found, this method returns null.

DistributionDataReader.GetBootstrapByInitKey Method

Returns all bootstrap entries in the database for a specific initkey.
public DistributionBootstrap GetBootstrapByInitKey(

string initKey

);
Parameters
initKey

Initialization Key to search for. This parameter cannot be null.
There is a limit of 25 characters for the length of the initKey.

Return Value
DistributionBootstrap array containing entries in the distribution
database corresponding to a given Hardware ID. If no entries are
found, this method returns null.

DistributionDataReader.GetPacketByHardwareId Method

Returns all packets waiting for download by the device with the specific
hardwareId. public DistributionPacket[ ] GetPacketByHardwareId(

string hardwareId

);
Parameters
hardwareId

Hardware ID of the device to search packets for. This parameter
cannot be null. There is a limit of 50 characters for the length
of the hardwareId.

Return Value
DistributionPacket array containing packets in the distribution
database waiting for download by given Hardware ID. If no
packets are found, this method returns null.

DistributionDataReader.GetPacketById Method

Returns packet corresponding to a specific Packet ID.
public DistributionPacket GetPacketById(

long id

);
Parameters
id

ID of corresponding packet obtained from the Core Database.
This value must be a 64-bit long integer greater than zero,
and cannot be negative.

Return Value
DistributionPacket with specific Packet Id. If no packets are
found, this method returns null.

DistributionDataReader.GetRequestLogByHardwareId Method

Returns all Request Logs in the database for a specific hardwareId, filtered
by start and end dates.
public DistributionRequestLog[ ] GetRequestLogByHardwareId(

string hardwareId,
string startDate,
string endDate

);
Parameters
hardwareId

Hardware ID of the device that made the request. Null is not
allowed. There is a limit of 25 characters for the length of
the initKey.

startDate

Start Date for filtering log records. This parameter can be null
or empty string.

endDate

End Date for filtering log records. This parameter can be null or
empty string.

Return Value
DistributionRequestLog array containing entries in the distribution
database corresponding to a given Hardware ID. If no entries are found,
this method returns null.
Remarks
The start and end date parameters are of string type, so that their values
are nullable. The format of these parameters must match the
DateTimeFormatInfo.SortableDateTimePattern. The values passed
in should also be UTC.
If null or empty string is passed in for either the startDate, or the
endDate, that parameter is excluded from the filter.
Example
The following method call
GetRequestLogByHardwareId(“abc”, null, “2005-01-01T00:00:00”);
will return all logs for device with HardwareD “abc” with no start
date filter, and the end date filter as 1st of January, 12:00:00 AM

Resolutions Class—The Resolutions class exposes methods for making adjustments to account settings and computer settings and may be primarily for customer satisfaction purposes.

Contains methods for CSR Resolutions.

System.Object
System.ComponentModel.MarshalByValueComponent
   System.Web.Services.WebService
      public class Resolutions: WebService Thread Safety This type is safe for multithreaded operations. Remarks This Web Service exposes methods that can be used by CSR personnel to make changes in the database. Note This class is assembly is only meant to be instantiated as a WebService as part of IIS. The security modules included as part of the Global class will enforce security permissions for the methods of this class.

Resolutions Members

Resolutions Constructor
Nothing to do in constructor
public Resolutions( );

Resolutions Methods—The methods of the Resolutions class are listed below in Table 3. Each method is discussed in more detail below.

TABLE 3
Resolutions Class Methods

| | |
|---|---|
| AddPrepaidTime | Adds given time unit to the specific Prepaid |
| | Device. |
| AddToPrepaidDevice- | Adds a specified amount to the Prepaid |
| Minutes | Device's total minutes field in database. This |
| | field is used in determining how close the |
| | device is to perpetuity. |
| CancelSubscription | Cancels a subscription schedule for a device |
| | effective immediately. |
| ConfigureDevice | Creates a configuration packet for a given |
| | device. |
| CreateSubscriptionPacket | Creates a subscription packet for a device. |
| CreateSubscriptionSchedule | Creates a subscription schedule for a device. |
| DecodeHLMChallenge | Decodes an HLM Challenge string into an |
| | HardwareLockedModeChallenge object. |
| DeregisterDevice | Deregisters (or Retires) a given device. |
| GenerateHLMResponse | Generates an HLM response for a given |
| | challenge string and device ID. |
| RecreatePacket | Recreates a packet with the given Packet |
| | (Job) Id. |
| RegisterPrepaidDevice | Registers a new Prepaid device. |
| RegisterSubscriptionDevice | Registers a new Subscription device. |
| ReregisterDevice | Re-registers a given device. |
| ResetLsn | Reset the Last Sequence Number of a |
| | specific device to the given LSN. |

Resolutions.AddPrepaidTime Method

Adds given time unit to the specific Prepaid Device.
public string AddPrepaidTime(

string requester,
int deviceId,
int minutes,
string account

);
Parameters
requester

Requester name indicating who is requesting this action.
This parameter cannot be null, or zero length string, and cannot
be greater than 46 characters.

deviceId

Device ID of the device for which time is being added. This
number cannot be negative.

minutes

Number of minutes to add to the device. This number must be
greater than zero.

account

Account of the customer that is requesting time be added to the
device. This cannot be null, or zero-length string. it must also
fit in the maximum size allowed for this string in the database.

Return Value
Tracking Id of the transaction for reference.

Resolutions.AddPrepaidTime Method

Adds a specified amount of time to the Prepaid Device's total minutes
field in database. This field is used in determining how close the device
is to perpetuity.
public string AddToPrepaidDeviceMinutes(

string requester,
int deviceId,
int minutesToAdd

);
Parameters
requester

Requester name indicating who is requesting this action.
This parameter cannot be null, or zero length string,
and cannot be greater than 46 characters.

deviceId

ID of the device for which Total Minutes field is being updated.
This parameter must be greater than or equal to zero.

minutesToAdd

Minutes to add to this device's record. This parameter must be
greater than zero.

Resolutions.CancelSubscription Method

Cancels a subscription schedule for a device effective immediately.
public void CancelSubscription(

string requester,
int deviceId

);
Parameters
requester

Requester name indicating who is requesting this action. This
parameter cannot be null, or zero length string, and cannot be
greater than 46 characters.

deviceId

Device ID of the device for which the subscription is being
cancelled. This parameter cannot be negative.

Resolutions.ConfigureDevice Method

Creates a configuration packet for a given device.
public void ConfigureDevice(

string requester,
int deviceId,
int enforcementLevel,
int gracePeriodInMinutes

);
Parameters
requester

Requester name indicating who is requesting this action. This
parameter cannot be null, or zero length string, and cannot be
greater than 46 characters.

deviceId

Device ID of the device whos configuration needs to be
changed.. This parameter cannot be negative.

enforcementLevel

Enforcement level to set on the device. This parameter must be
between 0 and 4 (both values included).

gracePeriodInMinutes

Grace period in minutes to set on the device. This parameter
cannot be negative.

Resolutions.CreateSubscriptionPacket Method

Creates a subscription packet for a device.
public void CreateSubscriptionPacket(

string requester,
int deviceId,
string endDate,
bool perpetual

);
Parameters
requester

Requester name indicating who is requesting this action.
This parameter cannot be null, or zero length string, and
cannot be greater than 46 characters.

deviceId

Device ID of the device for which the packet is being created.
This parameter cannot be negative.

endDate

End date when the subscription packet expires. If ‘perpetual’
parameter is true, then this parameter can be null.

perpetual

Marks if the subscription packet is a perpetual packet or not.

Remarks
The subscription packet for the device can have a given end date when the
subscription will end, or it can be marked as perpetual which makes
the device perpetually free after the packet is downloaded.

Resolutions.CreateSubscriptionSchedule Method

Creates a subscription schedule for a device.
public void CreateSubscriptionSchedule(

string requester,
int deviceId,
string startDate,
string endDate

);
Parameters
requester

Requester name indicating who is requesting this action. This
parameter cannot be null, or zero length string, and cannot be
greater than 46 characters.

deviceId

Device ID of the device for which the subscription schedule is
being created. This parameter cannot be negative.

startDate

StartDate for subscription. This parameter cannot be null.

endDate

End date for the subscription packet. This parameter can be null.
If this parameter is null, an indefinite end date is automatically
added by the server.

Resolutions.DecodeHLMChallenge Method

Decodes an HLM Challenge string into an AuthoritativeModeChallenge
object. When a computer determines fraudulent activities, it may put itself
in a reduced function state known as hardware locked mode mode
(HLM). The computer has extremely limited functionality, including
presentation of a coded message (challenge) that indicates the conditions
detected that caused the HLM state. This method decodes the challenge
string.
public AuthoritativeModeChallenge DecodeHLMChallenge(

string requester,
int deviceId,
string challengeString

);
Parameters
requester

Requester name indicating who is requesting this action. This
parameter cannot be null, or zero length string, and cannot be
greater than 46 characters.

deviceId

Device ID of the device am challenge is being decoded. This
number cannot be negative.

challengeString

The HLM challenge string. This parameter cannot be null.

Return Value
An HardwareLockedModeChallenge object that encapsulates the
challenge information.

Resolutions.DeregisterDevice Method

Deregisters (or Retires) a given device.
public void DeregisterDevice(

string requester,
int deviceId

);
Parameters
requester

Requester name indicating who is requesting this action. This
parameter cannot be null, or zero length string, and cannot be
greater than 46 characters.

deviceId

Device ID of the device that is being Deregistered. This number
cannot be negative.

Resolutions.GenerateHLMResponse Method

Generates an HLM response for a given challenge string and device ID.
This hadware locked mode response object contains the response
string needed to unlock device from HLM. The response string may
include a coded time value for resetting the device clock.
public HardwareLockedModeResponse GenerateHLMResponse(

string requester,
int deviceId,
string challengeString

);
Parameters
requester

Requester name indicating who is requesting this action. This
parameter cannot be null, or zero length string, and cannot
be greater than 46 characters.

deviceId

Device ID of the device HLM Response is being created. This
number cannot be negative.

challengeString

The HLM challenge string. This parameter cannot be null.

Return Value

Resolutions.RecreatePacket Method

Recreates a packet with the given Packet (Job) Id.
public void RecreatePacket(

string requester,
long packetId

);
Parameters
requester

Requester name indicating who is requesting this action. This
parameter cannot be null, or zero length string, and cannot be
greater than 46 characters.

packetId

ID of the packet that is being recreated. This parameter cannot
be negative.

Resolutions.RegisterPrepaidDevice Method

Registers a new Prepaid device.
public void RegisterPrepaidDevice(

string requester,
string initKey

);
Parameters
requester

Requester name indicating who is requesting this action. This
parameter cannot be null, or zero length string, and cannot be
greater than 46 characters.

initKey

The initkey of the new device that is being registered. This
parameter cannot be null, and cannot be larger than 25
characters.

Resolutions.RegisterSubscriptionDevice Method

Registers a new Subscription device.
public void RegisterSubscriptionDevice(

string requester,
string deviceName,
string initKey

);
Parameters
requester

Requester name indicating who is requesting this action.
This parameter cannot be null, or zero length string,
and cannot be greater than 46 characters.

deviceName

The name of the new device that is being registered.
This parameter cannot be null, and cannot be larger than
50 characters.

initKey

The initkey of the new device that is being registered.
This parameter cannot be null, and cannot be larger than
25 characters.

Resolutions.ReregisterDevice Method

Re-registers a given device.
public void ReregisterDevice(

string requester,
int deviceId,
string initKey

);
Parameters
requester

Requester name indicating who is requesting this action.
This parameter cannot be null, or zero length string, and
cannot be greater than 46 characters.

deviceId

Device ID of the device that is being Re-Registered.
This number cannot be negative.

initKey

The initKey of the device that is being Re-registered.
If the initkey passed in is null or empty string, the device
is bootstrapped to the same initKey.
If a new initKey is passed, the existing device is bound to
this new initKey. In this case, the initKey must not be greater
than 25 characters. This will only succeed if the device has not
been bootstrapped already to a client.

Resolutions.ResetLsn Method

Reset the Last Sequence Number of a specific device to the given LSN.
public void ResetLsn(

string requester,
int deviceId,
int newLsn

);
Parameters
requester

Requester name indicating who is requesting this action.
This parameter cannot be null, or zero length string, and cannot
be greater than 46 characters.

deviceId

Device ID of the device for LSN is being reset. This parameter
cannot be negative.

newLsn

The new LSN that the device's LSN is being reset to. This
parameter cannot be negative.

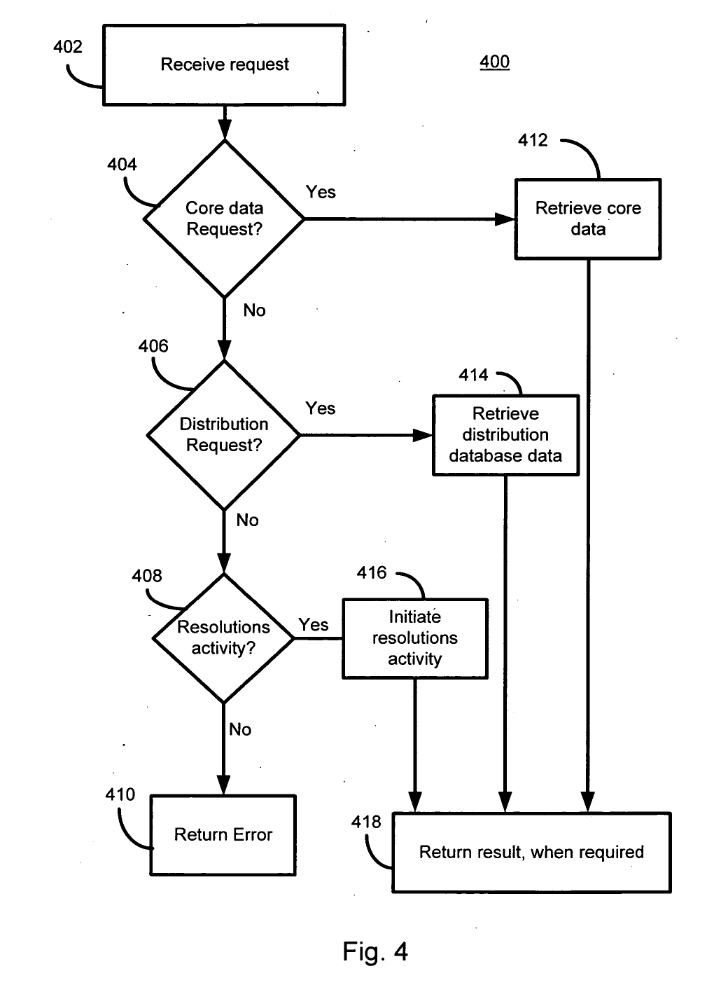

FIG. 4, a method 400 of processing a request related to supporting the pay-per-user or subscription business model, is discussed and described. A request may be received 402, for example, at a web services host 306 of FIG. 3, and processed to determine whether the request relates to core data processing, distribution data processing, or resolutions processing. The request may be parsed that decision block 404 to determine whether the request relates to core data. Core data may be related to both a user (e.g. a subscriber or other person with a contractual relationship with a service provider), a user's computer, or a provisioned peripheral or service on the user's computer. When the request corresponds to core data processing, the yes branch from block 400 for may be taken to block 412 where the requested data may be retrieved, or the processing completed, to fulfill the request. When the processing is completed at block 412 a result may be returned at block 418, when the request specifies a return result.

If it is determined at block 404 that the request does not relate to core data, the no branch from block 404 may be taken to block 406 and it may be determined whether the request relates to distribution data. When the request relates to distribution data the yes branch from block 406 may be taken to block 414, where the data processing request may be fulfilled, and a result returned at block 418 as specified by the request.

When the request is not relate to distribution data, the no branch from block 406 may be taken to block 408. If the request relates to resolutions activities, the yes branch from block 408 may be taken to block 416 and a particular method, for example, selected from one of the resolutions methods described above, may be invoked to comply with the requested activity. A result may be returned at block 418, when one made available by the given method.

When the request is not related to resolutions activity, the no branch from block 408 may be taken to block 410 and an error may be returned to the calling party indicating that the request was not able to be processed.

In operation, a user of a computer, such as metered computer 304, may call a customer service representative with a request to restore metered usage time because, for example, the user was on the phone with another service vendor. The customer service representative may query the core database 310 using a core database class supported method to determine the users device, for example, with a GetDeviceByName.

After determining the device identifier and, for example, when a particular transaction is in question, a query may be made using a method such as GetJobByDeviceID.

The customer service representative may also be able to query the distribution database 314 to determine if any pending transactions are available for the device, for example, using a GetPacketByHardwareId method call. If the customer service representative decides it is appropriate to restore time to the user's computer, it may be accomplished by a resolutions class method call, for example, CreateSubscriptionPacket. Thus, the customer service representative may be able to effectively interact with both the core database and the distribution database, as well as effecting changes as appropriate using the classes and methods described above.

Although the forgoing text sets forth a detailed description of numerous different embodiments of the invention, it should be understood that the scope of the invention is defined by the words of the claims set forth at the end of this patent. The detailed description is to be construed as exemplary only and does not describe every possibly embodiment of the invention because describing every possible embodiment would be impractical, if not impossible. Numerous alternative embodiments could be implemented, using either current technology or technology developed after the filing date of this patent, which would still fall within the scope of the claims defining the invention.

Thus, many modifications and variations may be made in the techniques and structures described and illustrated herein without departing from the spirit and scope of the present invention. Accordingly, it should be understood that the methods and apparatus described herein are illustrative only and are not limiting upon the scope of the invention.

We claim:

1. A method of providing customer service data related to a metered computer comprising:
receiving a request related to customer service activity;
determining whether the request relates to at least one of core data, distribution data, and resolutions processing;
retrieving data from a core database when the request includes a request for core data;
retrieving data from a distribution database when the request includes a request for distribution data; and
initiating an activity when the request includes a request corresponding to resolutions processing.

2. The method of claim 1, wherein determining whether the request relates to core data comprises determining when the request contains at least one of the methods GetConfiguration, GetDeviceByAccount, GetDeviceByHardwareId, GetDeviceById, GetDeviceByInitKey, GetDeviceByName, GetEmptyPacket, GetEmptyPrepaidDevice, GetEmptySubscriptionDevice, GetJobByDeviceId, GetJobByDeviceName, GetJobByHardwareId, GetJobByRequester, GetJobChildrenByParentJobId, GetPrepaidPurchaseByAccount, and GetPrepaidPurchaseByTrackingId.

3. The method of claim 1, wherein determining whether the request relates to distribution data comprises determining when the request contains at least one of the methods GetBootstrapByHardwareId, GetBootstrapByInitKey, GetPacketByHardwareId, GetPacketById, and GetRequestLogByHardwareId.

4. The method of claim 1, wherein determining whether the request relates to resolutions processing comprises determining when the request contains at least one of the methods AddPrepaidTime, AddToPrepaidDeviceMinutes, CancelSubscription, ConfigureDevice, CreateSubscriptionPacket, CreateSubscriptionSchedule, DecodeHLMChallenge, DeregisterDevice, GenerateHLMResponse, RecreatePacket, RegisterPrepaidDevice, RegisterSubscriptionDevice, ReregisterDevice, and ResetLsn.

5. A method of providing customer service data corresponding to a computing device operated in a pay-per-use or subscription business model comprising:
exposing methods for retrieving data corresponding to one of a customer or the computing device;
exposing methods for querying data corresponding to a distribution chain for at least one of the computing device, a related peripheral, and a related service;
exposing methods for adjusting one of operating data and business data related to the computing device.

6. The method of claim 5 wherein exposing methods for retrieving data corresponding to one of a customer or the computing device comprises exposing at least one of the methods GetConfiguration, GetEmptyPacket, GetEmptyPrepaidDevice, GetEmptySubscriptionDevice, GetPrepaidPurchaseByAccount, and GetPrepaidPurchaseByTrackingId.

7. The method of claim 5, wherein exposing methods for retrieving data corresponding to one of a customer or the computing device comprises exposing at least one of the methods GetDeviceByAccount, GetDeviceByHardwareId, GetDeviceById, GetDeviceByInitKey, GetDeviceByName.

8. The method of claim 7, wherein the at least one of the methods returns information using a schema comprising at least one data element containing ActivationDate, AutoDiagnostics, HardwareId, Id, LastActivityDate, LastSequenceNumber, Market, Name, Status, Type, UnderwriterProgramId.

9. The method of claim 5, wherein exposing methods for retrieving data corresponding to one of a customer or the computing device comprises exposing at least one of the methods GetJobByDeviceId, GetJobByDeviceName, GetJobByHardwareId, GetJobByRequester, and GetJobChildrenByParentJobId.

10. The method of claim 9, wherein the at least one of the methods returns information using a schema comprising at least one data element containing Children, DeviceId, Id, Log, ParentId, ParentType, Requester, and Status.

11. The method of claim 5, wherein exposing methods for querying data corresponding to a distribution chain for at least one of the computing device, a related peripheral, and a related service comprises exposing at least one of the methods GetBootstrapByHardwareId, GetBootstrapByInitKey, GetPacketByHardwareId, GetPacketById, and GetRequestLogByHardwareId.

12. The method of claim 5, wherein exposing methods for adjusting one of operating data and business data related to the computing device comprises exposing at least one of the methods AddPrepaidTime, AddToPrepaidDeviceMinutes, CancelSubscription, ConfigureDevice, CreateSubscriptionPacket, CreateSubscriptionSchedule, DecodeHLMChallenge, DeregisterDevice, GenerateHLMResponse, RecreatePacket, RegisterPrepaidDevice, RegisterSubscriptionDevice, ReregisterDevice, and ResetLsn.

13. A computer-readable medium having computer executable modules for execution on a computer supporting web-based customer service operations comprising:
a plurality of core data modules that process information corresponding to at least one of a metered use computer and a customer associated with the metered use computer;
a plurality of distribution data modules that process information corresponding to distribution data associated with the metered use computer; and
a plurality of resolutions modules that process information for resolving issues.

14. The computer-readable medium of claim 13, wherein the plurality of core data modules includes at least one of GetConfiguration, GetDeviceByAccount, GetDeviceByHardwareId, GetDeviceById, GetDeviceByInitKey, GetDeviceByName, GetEmptyPacket, GetEmptyPrepaidDevice, GetEmptySubscriptionDevice, GetJobByDeviceId, GetJobByDeviceName, GetJobByHardwareId, GetJobByRequester, GetJobChildrenByParentJobId, GetPrepaidPurchaseByAccount, and GetPrepaidPurchaseByTrackingId

15. The computer-readable medium of claim 13, wherein the plurality of distribution data modules includes at least one of GetBootstrapByHardwareId, GetBootstrapByInitKey, GetPacketByHardwareId, GetPacketById, and GetRequestLogByHardwareId.

16. The computer-readable medium of claim 13, wherein the plurality of resolutions modules includes at least one of AddPrepaidTime, AddToPrepaidDeviceMinutes, CancelSubscription, ConfigureDevice, CreateSubscriptionPacket, CreateSubscriptionSchedule, DecodeHLMChallenge, DeregisterDevice, GenerateHLMResponse, RecreatePacket, RegisterPrepaidDevice, RegisterSubscriptionDevice, ReregisterDevice, and ResetLsn.
